(19) United States
(12) Patent Application Publication
(10) Pub. No.: US 2024/0330651 A1
(43) Pub. Date: Oct. 3, 2024

(54) DISCOVERING INTERPRETABLE DYNAMICALLY EVOLVING RELATIONS (DIDER)

(71) Applicant: Honda Motor Co., Ltd., Tokyo (JP)

(72) Inventors: Enna SACHDEVA, San Jose, CA (US); Chiho CHOI, San Jose, CA (US)

(21) Appl. No.: 18/194,844

(22) Filed: Apr. 3, 2023

(51) Int. Cl. G06N 3/0442; G06N 5/043

(52) U.S. Cl. CPC G06N 3/0442; G06N 5/043

(57) ABSTRACT

According to one aspect, discovering interpretable dynamically evolving relations (DIDER) may including using a DIDER model for multi-agent interactions represented by an execution set of edge embeddings indicative of trajectory interactions between two or more agents for one or more time steps. The DIDER model may be trained by feeding a training set of edge embeddings to a long short-term memory network (LSTM) forward to generate an LSTM forward output, feeding the training set of edge embeddings to a LSTM reverse to generate an LSTM reverse output, feeding the LSTM forward output to a duration encoder to generate an edge duration output, and training the DIDER model based on a probability distribution for one or more different edge types obtained by feeding the LSTM forward output or the LSTM reverse output to an edge prior and an edge encoder.

### BACKGROUND

Real-world applications such as autonomous driving, mobile robot navigation, and air-traffic management may involve multi-agent interactions for joint behavior prediction and complex decision making. Modeling these interactions may be useful for understanding the underlying dynamic behavior of the agents. For example, the future behavior (e.g., yielding or right of way) of a Vehicle Approaching an intersection may be influenced by another approaching vehicle. However, it may be challenging to model these inter-agent interactions, as ground truth interactions between agents may not be known.

### BRIEF DESCRIPTION

According to one aspect, a system for discovering interpretable dynamically evolving relations (DIDER) may include a processor and a memory. The memory may store one or more instructions. The processor may execute one or more of the instructions stored on the memory. For example, the processor may perform learning a DIDER model for multi-agent interactions represented by a set of edge embeddings indicative of trajectory interactions between two or more agents for one or more time steps by feeding the set of edge embeddings to a long short-term memory network (LSTM) forward to generate an LSTM forward output, feeding the set of edge embeddings to a LSTM reverse to generate an LSTM reverse output, feeding the LSTM forward output to a duration encoder to generate an edge duration output, and training the DIDER model based on a probability distribution for one or more different edge types obtained by feeding the LSTM forward output or the LSTM reverse output to an edge prior and an edge encoder.

The set of edge embeddings indicative of trajectory interactions between two or more agents may be derived from a graph neural network (GNN). Nodes of the GNN represent the two or more agents and edges of the GNN represent the relationships between two connected nodes. The edge encoder may be conditioned on full trajectories for all time steps. The edge prior may be conditioned on an observation and a relation prediction from a previous time step. The processor may feed an output of the edge encoder to a decoder to predict future states of two or more of the agents. The decoder may include a multi-layer perceptron (MLP). The processor may train the DIDER model based on maximizing an evidence lower bound (ELBO). The LSTM reverse output may be indicative of future states of the set of edge embeddings. The processor may feed a concatenation of the LSTM forward output and the LSTM reverse output to the edge encoder. The edge prior or the edge encoder may be implemented via a softmax function.

According to one aspect, a computer-implemented method for discovering interpretable dynamically evolving relations (DIDER) by learning a DIDER model for multi-agent interactions represented by a set of edge embeddings indicative of trajectory interactions between two or more agents for one or more time steps may include feeding the set of edge embeddings to a long short-term memory network (LSTM) forward to generate an LSTM forward output, feeding the set of edge embeddings to a LSTM reverse to generate an LSTM reverse output, feeding the LSTM forward output to a duration encoder to generate an edge duration output, and training the DIDER model based on a probability distribution for one or more different edge types obtained by feeding the LSTM forward output or the LSTM reverse output to an edge prior and an edge encoder.

The set of edge embeddings indicative of trajectory interactions between two or more agents may be derived from a graph neural network (GNN). Nodes of the GNN represent the two or more agents and edges of the GNN represent the relationships between two connected nodes. The edge encoder may be conditioned on full trajectories for all time steps. The edge prior may be conditioned on an observation and a relation prediction from a previous time step.

According to one aspect, a system for discovering interpretable dynamically evolving relations (DIDER) may include a processor and a memory. The memory may store one or more instructions. The processor may execute one or more of the instructions stored on the memory. For example, the processor may perform DIDER using a DIDER model for multi-agent interactions represented by an execution set of edge embeddings indicative of trajectory interactions between two or more agents for one or more time steps. The DIDER model may be trained by feeding a training set of edge embeddings to a long short-term memory network (LSTM) forward to generate an LSTM forward output, feeding the training set of edge embeddings to a LSTM reverse to generate an LSTM reverse output, feeding the LSTM forward output to a duration encoder to generate an edge duration output, and training the DIDER model based on a probability distribution for one or more different edge types obtained by feeding the LSTM forward output or the LSTM reverse output to an edge prior and an edge encoder.

The training set of edge embeddings indicative of trajectory interactions between two or more agents may be derived from a graph neural network (GNN). Nodes of the GNN represent the two or more agents and edges of the GNN represent the relationships between two connected nodes. The edge encoder may be conditioned on full trajectories for all time steps. The edge prior may be conditioned on an observation and a relation prediction from a previous time step. The processor may feed an output of the edge encoder to a decoder to predict future states of two or more of the agents. The decoder may include a multi-layer perceptron (MLP).

### BRIEF DESCRIPTION OF THE DRAWINGS

FIG. 1 is an exemplary component diagram of a system for discovering interpretable dynamically evolving relations (DIDER), according to one aspect.

FIG. 2 is an exemplary flow diagram of a computer-implemented method for discovering interpretable dynamically evolving relations (DIDER), according to one aspect.

FIG. 3 is an exemplary architecture in association with the system for discovering interpretable dynamically evolving relations (DIDER) of FIG. 1, according to one aspect.

FIG. 4 is an exemplary architecture in association with the system for discovering interpretable dynamically evolving relations (DIDER) of FIG. 1, according to one aspect.

FIGS. 5A-5B are illustrations of exemplary scenarios in association with discovering interpretable dynamically evolving relations (DIDER), according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multi-core processors and co-processors and other multiple single and multi-core processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a Vehicle Bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous Vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment. Exemplary agents may include robots, vehicles, or other self-propelled machines. The agent may be autonomously, semi-autonomously, or manually operated.

As used herein, an edge may connect two nodes within a graph and may represent a relationship or an interaction between the two nodes. Therefore, an edge, a relationship, or an interaction may be used interchangeably herein.

Generally, DIDER may be implemented via an unsupervised learning framework for discovering interpretable dynamic multi-agent interactions from observations which enables relationships between two or more agents to be discovered across a set of time steps. DIDER may leverage a Variational Autoencoder (VAE) framework to discover interpretable dynamic temporal interactions while simultaneously learning the dynamic model of a system. DIDER may incorporate intrinsic interpretability into a DIDER model by decoupling an interaction prediction task into sub-interaction and duration predictions. Stated another way, the DIDER framework may be an end-to-end explicit interaction modeling framework, with intrinsic interpretability, by disentangling dynamic interaction prediction into sub-interaction prediction and duration prediction.

The DIDER model may use trajectory prediction as a surrogate task for learning interpretable dynamically evolving interactions. By predicting each sub-interaction's start and end time, the DIDER model may provides enhanced interpretability of the latent interactions while improving the performance on downstream trajectory prediction tasks.

The DIDER model may be a generic framework for modeling dynamic interactions and may be flexible to be incorporated into any existing VAE-like relational inference frameworks to improve interactions interpretability and trajectory prediction performance.

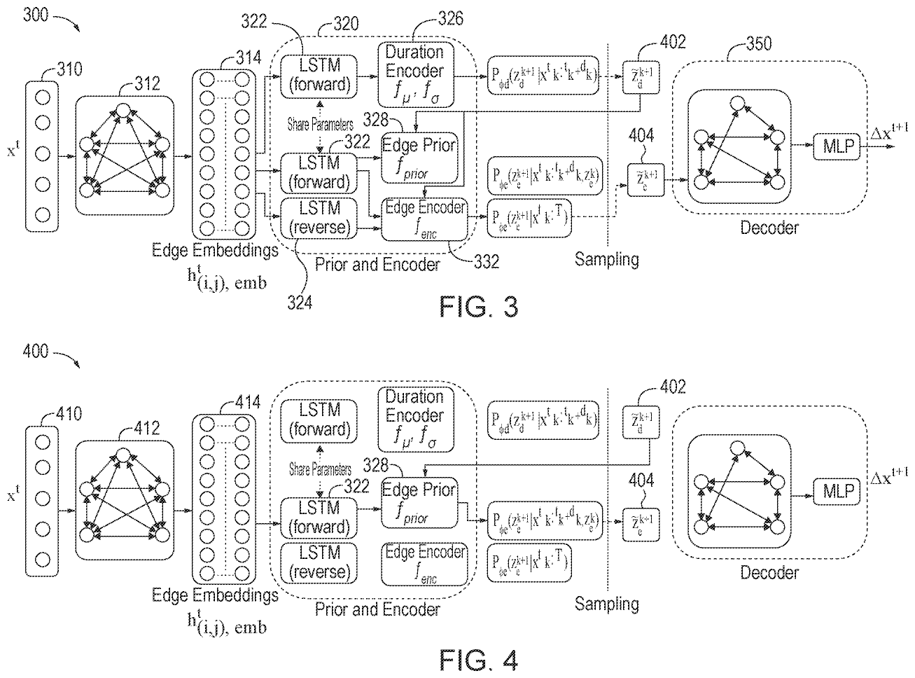

During a training phase, the DIDER model may be trained or learned by providing a set of trajectories for a set of agents to the architecture 300 of FIG. 3, notably including a duration encoder. Once the DIDER model is trained, the DIDER model may be implemented during an execution phase where a set of trajectories for a set of agents may be provided to the architecture 400 of FIG. 4 to produce a discovered output set of dynamically evolving relations which may be easily interpretable.

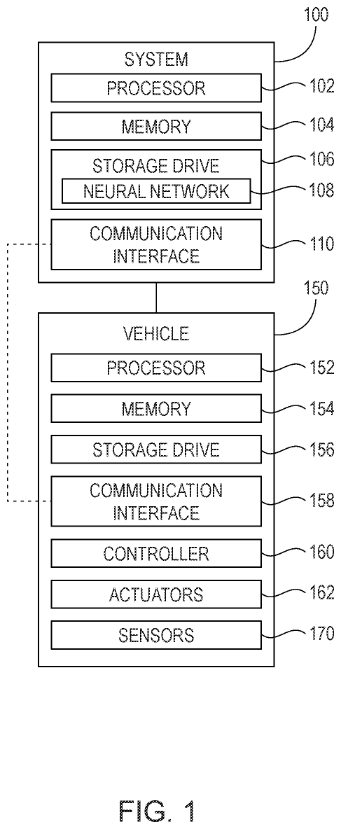

FIG. 1 is an exemplary component diagram of a system 100 for discovering interpretable dynamically evolving relations (DIDER), according to one aspect. The system 100 for DIDER may include a processor 102, a memory 104, a storage drive 106 storing a neural network 108, and a communication interface 110. The memory 104 may store one or more instructions. The processor 102 may execute one or more of the instructions stored on the memory 104 to perform one or more acts, actions, and/or steps. The communication interface 110 may be communicatively coupled to a vehicle 150, such as to a communication interface 158 of an autonomous vehicle. The vehicle 150 may include a processor 152, a memory 154, a storage drive 156, the communication interface 158, a controller 160, actuators 162, and sensors 170. The processor 102, memory 104, and storage drive 106 of the system 100 for DIDER may facilitate training the DIDER model and communicate the DIDER model to the vehicle 150 via the communication interfaces 110, 158. At runtime, the sensors 170 on the vehicle 150 may receive the trajectories of other vehicles (i.e., agents) and use these trajectories as input to the execution architecture 400 described in FIG. 4 to output the discovered output set of dynamically evolving relations which may be easily interpretable. Thereafter, the controller 160 may determine or generate actions which may be implemented via the actuators 162 based on the output set of dynamically evolving relations.

Effective understanding of dynamically evolving multi-agent interactions may be useful for capturing the underlying behavior of agents in social systems. It is usually challenging to observe these interactions directly, and therefore modeling latent interactions may be useful for realizing the complex behaviors. Dynamic Neural Relational Inference (DNRI) may capture explicit inter-agent interactions at every time step. However, predictions at every step using DNRI may result in noisy interactions and may lack intrinsic interpretability. DIDER may be a generic end-to-end interaction modeling framework with intrinsic interpretability capabilities. DIDER discovers an interpretable sequence of inter-agent interactions by disentangling the task of latent interaction prediction into sub-interaction prediction and duration estimation. By imposing the consistency of a sub-interaction type over an extended time duration, the framework may achieve intrinsic interpretability without requiring any post-hoc inspection.

The processor 102 of the system 100 for DIDER may perform learning a DIDER model for multi-agent interactions, as discussed in greater detail below. According to one aspect, multi-agent interactions may be represented by a set of edge embeddings indicative of trajectory interactions between two or more agents for one or more time steps. Edge embeddings may include features (e.g., position, velocity, acceleration, at a given time step) of nodes and/or agents. The edge embeddings may be derived from trajectories of the two or more agents across the set of time steps and/or a corresponding graph network of the respective trajectories. Edge features may be determined by subtracting two corresponding agent features. The set of edge embeddings indicative of trajectory interactions between two or more agents may be derived from a graph neural network (GNN). Nodes of the GNN represent the two or more agents and edges of the GNN represent the relationships between two connected nodes.

### Dynamic Neural Relational Inference (DNRI)

The system 100 for DIDER may include or incorporate aspects of Dynamic Neural Relational Inference (DNRI) framework in its architecture. DNRI may model the dynamic evolving relation types between agents by predicting z_{i,j}^{t} at each time step. DNRI may simultaneously learn the dynamic model of the interacting system. DNRI may formulate this problem using a Conditional Variational Autoencoder (CVAE) framework. For example, consider a set of N agents with their trajectories of duration T denoted as: x₁^{1:T}, x₂^{1:T}, . . . , x_{N}^{1:T}. DNRI may predict the trajectories using relational embeddings. The interactions between entities may be represented by z_{i,j}^{t}ϵ{1, 2, . . . , e} for every pair of entities (i,j) at time step t, where e denotes the number of possible interaction types between entities.

LSTMs may be used to model the dynamic prior p_{ϕ}(z|x) and encoder q_{ϕ}(z|x). At each time step the encoder may be conditioned on a full trajectory, while the prior may be conditioned on the observation and relation prediction from previous steps:

$${p}_{ϕ} ( z \vert x ) := {\prod }_{t = 1}^{T} {p}_{ϕ} ( {z}^{t} \vert {x}^{1 : L} , {z}^{1 : t - 1} ) , {q}_{ϕ} ( z \vert x ) := {\prod }_{t = 1}^{T} {q}_{ϕ} ( {z}^{t} \vert {x}^{1 : T} ) \qquad ( 1 )$$

The edge encoder may be conditioned on full trajectories for all time steps. The edge prior may be conditioned on an observation and a relation prediction from a previous time step.

The decoder may then predict the future states of the entities x. The decoder may be the formulation conditioning on the dynamic zₜ sampled from the encoder at every time step t:

$${p}_{θ} ( x \vert z ) := {Π}_{t = 1}^{T} {p}_{θ} ( {x}^{t + 1} \vert {x}^{1 : t} , {z}^{1 : t} ) \qquad ( 2 )$$

θ, ϕ may be trainable parameters of probability distributions, which may be optimized by maximizing the following evidence lower bound (ELBO):

$$( ϕ , θ ) = ( z \vert x ) [ log {p}_{θ} ( x \vert z ) ] - K L [ {q}_{ϕ} ( z \vert x ) ‖ {p}_{ϕ} ( z \vert x ) ] \qquad ( 3 )$$

The processor 102 may feed the set of edge embeddings to a long short-term memory 104 network (LSTM) forward to generate an LSTM forward output. The processor 102 may feed the set of edge embeddings to a LSTM reverse to generate an LSTM reverse output (which may consider hidden information and future information). The processor 102 may feed the LSTM forward output to a duration encoder to generate an edge duration output. LSTM forward may take history information relative to time step t, and take all the information from previous time steps, until time step t and create an output. LSTM reverse takes the future trajectory or take all the information from the future, future means time step t until the end of the trajectory.

Trajectory Segmentation and Skill Discovery from Raw Trajectories (SKID)

SKID may be an unsupervised framework utilized to segment the trajectories into reoccurring patterns (skills) from unlabeled demonstrations. SKID may frame the problem using Variational Autoencoders (VAEs), with latent space z={z_{d}, zₛ} describing the properties of a segment, where z_{d} and zₛ represent a duration of a skill and a skill type.

SKID may model the skill duration z_{d} with a Gaussian distribution given a prior i.e., z_{d}˜ [symbol] (μ_{d}, σ_{d}²). Each skill duration z_{d} may be obtained using the remainder of the trajectory, i.e., the part of the trajectory that has not been explained by all previous z_{d}. This extracted sub-trajectory T may then be used for learning the skill type zₛ. Assuming that a trajectory includes N segments, this iterative process may be repeated N times until the last time step of the trajectory is reached. The learning may be achieved by jointly optimizing the generative model and the inference network by maximizing the ELBO. SKID may utilize full trajectories for learning skills and duration, making it suitable for offline settings.

### Discovering Interpretable Dynamically Evolving Relations (DIDER) Model

According to one aspect, one objective of DIDER may be to discover an interpretable sequence of sub-interactions among agents from their observations. The DIDER model may be built by disentangling the task of predicting dynamic interactions into two parts—sub-interaction prediction and duration estimation, both of which may be unobserved. This problem may be modeled using a CVAE framework with two latent variables zₑ and z_{d}. These latent variables may be discrete and continuous latent variables zₑ and z_{d} which may represent agents' interaction (e.g., edge) type and the corresponding time duration. The DIDER model may learn an unknown number of varying lengths of sub-interactions from the observations. According to one aspect, the formulation may involve the simultaneous prediction of time duration and interaction type between agents. An encoder and a prior model may be utilized based on sequential segmentation modeling. Additionally, the DIDER model may be trained by maximizing ELBO. Thus, the processor 102 may train the DIDER model based on maximizing the ELBO.

In DNRI, the prior and the encoder may predict interaction at every time step t, by capturing past and (past+future) instances of trajectories, respectively. By contrast, DIDER may predict the time duration of an interaction type with the duration encoder using the last segment of past trajectories. The time duration sampled from the duration prior may be then used by edge prior and edge encoder to learn an interaction type corresponding to the specific segment of the trajectory.

### Prior and Encoder

To model evolving sequence of sub-interactions, DIDER may learn prior probabilities on the edge duration z_{d} and edge types zₑ conditioned on the past. The input at each time step may be passed through a neural network, such as a GNN to produce edge embeddings, as follows:

$${h}_{i , 1}^{t} = {f}_{e m b} ( {x}_{i}^{t} ) , \qquad ( 4 )$$

$$v \to e : {h}_{( i , j ) , 1}^{t} = {f}_{e}^{1} ( [ {h}_{i , 1}^{t} , {h}_{j , 1}^{t} ] ) , \qquad ( 5 )$$

$$e \to v : {h}_{( i , j ) , 2}^{t} = {f}_{v}^{1} ( {\sum }_{i \neq j} {h}_{( i , j ) , 1}^{t} ) , \qquad ( 6 )$$

$$v \to e : {h}_{( i , j ) , emb}^{t} = {f}_{e m b}^{2} ( [ {h}_{i , 2}^{t} , {h}_{j , 2}^{t} ] ) . \qquad ( 7 )$$

The architecture 300, 400 for DIDER (e.g., FIGS. 3-4) may implement neural message passing in a graph where vertices v represent entities i, and edges e represent the relations between entities pairs (i,j). f_{emb}, fₑ¹, and fᵥ¹ may be multi-layer perceptrons (MLPs). The embeddings h_{(i,j)1}^{t} may depend on xᵢ and xⱼ, while h_{(i,j)2}^{t} may use information from the whole graph. This neural message passing architecture may output a per time step edge embedding h_{(i,j),emb}^{t}, which may be fed into the LSTM forward and LSTM reverse networks to model the probabilities over edge duration and edge types. The system may perform message passing in the neural network or GNN, to obtain the messages between different agents which are connected in the graph.

$${h}_{( i , j ) , prior}^{t} = {LSTM}_{forwaτd} ( {h}_{( i , j ) , emb}^{t} , {h}_{( i , j ) , prior}^{t - 1} ) \qquad ( 8 )$$

$${h}_{( i , j ) , reverse}^{t} = {LSTM}_{reverse} ( {h}_{( i , j ) , emb}^{t} , {h}_{( i , j ) , reverse}^{t + 1} ) \qquad ( 9 )$$

### Duration Encoder

The prior and encoder 320 may include a duration encoder which ensures that an interaction or relationship between two agents, does not change too quickly over a period of time. In other words, the duration encoder ensures that this relationship stays constant for a certain interval of time, as a learned time duration (e.g., how long an edge should stay constant, as a constraint). The edge duration z_{d}^{k} may be modeled as a continuous latent variable, and may determine the duration (dₖ) of an interaction type for k^{th} segment of an edge. With an initial burn-in period (e.g., observation period with ground truth trajectory) of T_{obs}, the duration encoder may model the probability distribution of the duration (d₁) of first segment (k=1) of an interaction as

$${p}_{{ϕ}_{d}} ( {z}_{d}^{1} \vert {x}^{1 : {T}_{o b s}} ) ,$$

where t₁=0, d₀=T_{obs}, and tₖ and tₖ+dₖ represent the start time and the end time of k^{th} segment. T_{remaining} may be the duration of the remainder of the trajectory, which may not be utilized for duration estimation of previous sub-interactions. It may be represented as T−tₖ−dₖ.

### Parameterization of Continuous Latent Variables, Duration Encoder

The system may parameterize

$${p}_{{ϕ}_{d}} ( {z}_{d}^{k} \vert x )$$

by a Gaussian distribution, i.e.,

$${p}_{{ϕ}_{d}} ( {z}_{d}^{k} \vert x ) = ( {μ}_{k} , {σ}_{k}^{2} ) ,$$

where μₖ, and σₖ² may be parameterized by neural networks. The prior may be a Gaussian distribution with p(z_{d})= [symbol] (μ₀, σ₀²). Reparameterization for the Gaussian distributed z_{d} may be implemented to sample the time duration factor z_{d}^{k}=μₖ+σₖϵ, where ϵ may be an auxiliary noise variable ϵ˜ [symbol] (0,1). Then the time duration of the k^{th} segment may be estimated as:

$$\begin{matrix}{μ}_{k + 1} = tanh ( {f}_{μ} ( {h}_{( i , j ) , prior}^{{t}_{k} + {d}_{k}} ) ) , \\ {σ}_{k + 1} = sigmoid ( {f}_{σ} ( {h}_{( i , j ) , prior}^{{t}_{k} + {d}_{k}} ) ) , \\ {p}_{{ϕ}_{d}} ( {z}_{d}^{k + 1} \vert {x}^{{t}_{k} : {t}_{k} + {d}_{k}} ) = ( {μ}_{k + 1} , {σ}_{k + 1}^{2} ) , \\ {z}_{d}^{k + 1} = {μ}_{k + 1} , {σ}_{k + 1} ϵ , \\ {d}_{k + 1} = {z}_{d}^{k + 1} \cdot {T}_{remaining} ,\end{matrix} \qquad ( 10 )$$

where fᵤ, f_{σ} may be realized using MLPs.

The processor 102 may feed an output of the edge encoder to a decoder to predict future states of two or more of the agents. The decoder may include a multi-layer perceptron (MLP).

### Edge Prior and Edge Encoder

The edge prior probabilities over edge types may be modeled in an autoregressive manner. For each segment duration dₖ₊₁ sampled from the duration encoder, the prior probabilities over edge types may be conditioned on the relation type predicted in the previous segment (zₑ^{k}) as well as the sequence of observations in that segment, as following:

$${p}_{{ϕ}_{e}} ( {z}_{( i , j )}^{k + 1} \vert {x}^{{t}_{k} : {t}_{k} + {d}_{k}} , {z}_{e}^{k} ) := softmax ( {f}_{prior} ( {h}_{( i , j ) , prior}^{{t}_{k} + {d}_{k}} ) ) \qquad ( 11 )$$

$${p}_{{ϕ}_{e}} ( {z}_{e} \vert x ) := {Π}_{k = 1}^{K} {p}_{{ϕ}_{e}} ( {z}_{e}^{k + 1} \vert {x}^{{t}_{k} : {t}_{k} + {d}_{k}} , {z}_{e}^{k} ) \qquad ( 12 )$$

The dependence of previous zₑ^{k} to next zₑ^{k+1} may be encoded in the hidden state h_{(i,j),prior}^{t}^{ₖ}^{+d}^{ₖ}.

During training, the encoder may compute the approximate distribution of edge types for every segment by using the information of the whole sequence (i.e., past segment and future). The true posterior over the latent space may be a function of the future states of the observed variable. Therefore, a LSTM reverse may be utilized to capture future states of the sequence. The relational embedding h_{(i,j),emb}^{t} may be passed through a LSTM reverse and concatenated with the results of LSTM forward to estimate posterior as follows:

$${q}_{{ϕ}_{e}} ( {z}_{( i , j )}^{k + 1} \vert x ) := softmax ( {f}_{enc} ( [ {h}_{( i , j ) , reverse}^{{t}_{k} + {d}_{k}} , {h}_{( i , j ) , prior}^{{t}_{k} + {d}_{k}} ] ) ) \qquad ( 13 )$$

The encoder may approximate distribution of interactions for each segment as follows:

$${q}_{{ϕ}_{e}} ( {z}_{e} \vert x ) := {Π}_{k = 1}^{K} {p}_{{ϕ}_{e}} ( {z}_{e}^{k + 1} \vert {x}^{{t}_{k} : T} ) \qquad ( 14 )$$

The encoder and prior models may share parameters, and use ϕₑ to refer to the parameters of both of these models.

### Parameterization of Discrete Latent Variables, Edge Prior and Edge Encoder

The system may parameterize discrete categorical distribution with a continuous approximation function (i.e., softmax) to obtain probability distribution over each edge type. The processor 102 may train the DIDER model based on a probability distribution for one or more different edge types obtained by feeding the LSTM forward output or the LSTM reverse output to an edge prior and an edge encoder. The sampling may be done via reparameterization by first sampling a vector g of independent and identically distributed samples drawn from Gumbel (0, 1) and computing the following:

$${z}_{{e}_{( i , j )}} = softmax ( h ( i , j ) + g / τ ) \qquad ( 15 )$$

where τ may be a softmax temperature which controls the sample smoothness.

Thus, the LSTM reverse output may be indicative of future states of the set of edge embeddings. The processor 102 may feed a concatenation of the LSTM forward output and the LSTM reverse output to the edge encoder. The edge prior or the edge encoder may be implemented via the softmax function.

### Framework of Edge Prior and Edge Encoder

For the general formulation of edge prior and encoder modules, discussed in Equations (12) and (14), when the number of segments K is hardcoded as equal to time horizon T, corresponding to dₖ=1, the formulation of edge prior and encoder may be factorized as:

$${p}_{{ϕ}_{e}} ( {z}_{e} \vert x ) := {Π}_{t = 1}^{T} {p}_{{ϕ}_{e}} ( {z}_{e}^{t + 1} \vert {x}^{1 : t} , {z}_{e}^{1 : t - 1} ) \qquad ( 16 )$$

$${q}_{{ϕ}_{e}} ( {z}_{e} \vert x ) := {Π}_{t = 1}^{T} {p}_{{ϕ}_{e}} ( {z}_{e}^{t + 1} \vert x ) \qquad ( 17 )$$

In this way, DIDER may provide a generic framework with a time duration encoder, which provides additional flexibility for improving the interpretability of models which follows a VAE-like framework, such as DNRI.

### Decoder

A decoder may be used to predict the trajectory given the observations of the entities, and the sampled relation types at every time step t. An autoregressive model may be utilized, which factorizes as follows:

$${p}_{θ} ( x \vert {z}_{e} ) : = {Π}_{t = 1}^{T} {p}_{θ} ( {x}^{t + 1} \vert {x}^{1 : t} , {z}_{e}^{1 : t} ) \qquad ( 18 )$$

The ground truth states may be provided to the decoder during training.

### Training and Inference

The system may jointly train the generative and inference model parameters θ, ϕ_{d} and ϕₑ, by maximizing the ELBO:

$$( θ , {ϕ}_{d} , {ϕ}_{e} ) = ( {z}_{e} \vert x ) [ log {p}_{{θ}_{d}} ( x \vert {z}_{e} ) ] - {β}_{d} ( K L ( {q}_{{ϕ}_{d}} ( {z}_{d} \vert x ) ‖ p ( {z}_{d} ) ) - {C}_{d} ) \text{} - {β}_{e} ( K L ( {q}_{{ϕ}_{e}} ( {z}_{e} \vert x ) ‖ {p}_{{θ}_{e}} ( {z}_{e} \vert x ) ) - {C}_{e} ) \qquad ( 19 )$$

where β_{d}, βₑ may be constant scaling factors, and C_{d}, Cₑ, may be information capacity terms. The first term may facilitate reconstruction of the data, while the KL divergence may cause the DIDER model to stay close to a given prior. Further, to enforce disentanglement, β-VAE formulation may be implemented. Capacity terms may be added to the ELBO. Since DIDER discovers a sequence of sub-interactions for each edge individually, DIDER may add a complexity of O(n²T), where n may be the number of agents.

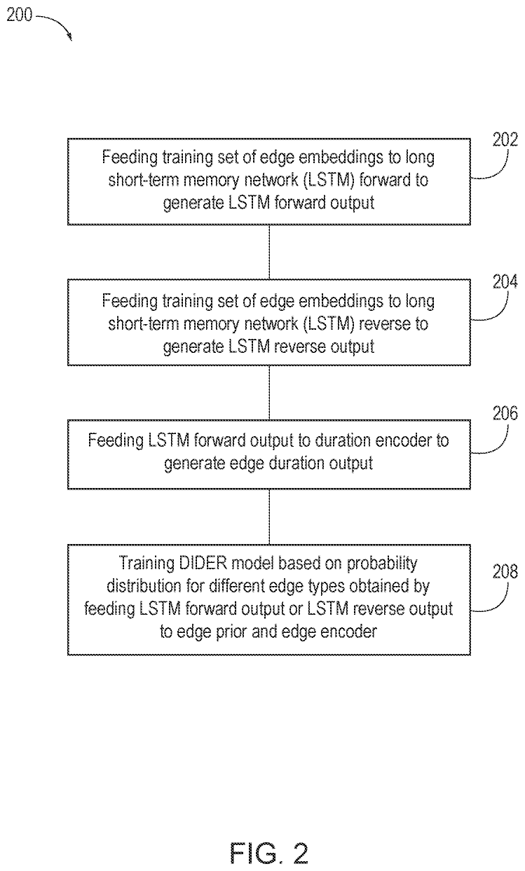

FIG. 2 is an exemplary flow diagram of a computer-implemented method 200 for discovering interpretable dynamically evolving relations (DIDER), according to one aspect. The computer-implemented method 200 for DIDER may be achieved by learning a DIDER model for multi-agent interactions represented by a set of edge embeddings indicative of trajectory interactions between two or more agents for one or more time steps may include feeding 202 the set of edge embeddings to a long short-term memory 104 network (LSTM) forward to generate an LSTM forward output, feeding 204 the set of edge embeddings to a LSTM reverse to generate an LSTM reverse output, feeding 206 the LSTM forward output to a duration encoder to generate an edge duration output, and training 208 the DIDER model based on a probability distribution for one or more different edge types obtained by feeding the LSTM forward output or the LSTM reverse output to an edge prior and an edge encoder.

FIG. 3 is an exemplary architecture 300 in association with the system 100 for discovering interpretable dynamically evolving relations (DIDER) of FIG. 1, according to one aspect. The architecture 300 of FIG. 3 may be utilized to train or learn a DIDER model for multi-agent interactions. According to one aspect, one or more input trajectories 310 may be fed to a fully-connected graph neural network (GNN) 312 to produce edge embeddings 314 at every time step. These may be aggregated using LSTM forward 322 and LSTM reverse 324 to encode the past and future trajectories. The LSTM forward output may be fed to a duration encoder 326 to generate an edge duration output. The duration prior and the edge prior 328 may be computed as a function of the past trajectory, and the edge encoding may be computed as a function of both past and future. The edge types may be sampled from the edge encoder 332 during training and edge prior 328 during inference. The decoder 350 may predict the state of the entities at the next time step. In this way, DIDER models 402 and 404 may be generated.

FIG. 4 is an exemplary architecture 400 in association with the system 100 for discovering interpretable dynamically evolving relations (DIDER) of FIG. 1, according to one aspect. The architecture 400 of FIG. 4 may be utilized to determine multi-agent interactions using the DIDER model trained or learned from FIG. 3. According to one aspect, one or more input trajectories 410 may be fed to a fully-connected graph neural network (GNN) 412 to produce edge embeddings 414 at every time step. These may be aggregated using LSTM forward 322 to encode the past trajectories. The duration prior and the edge prior 328 may be computed as a function of the past trajectory.

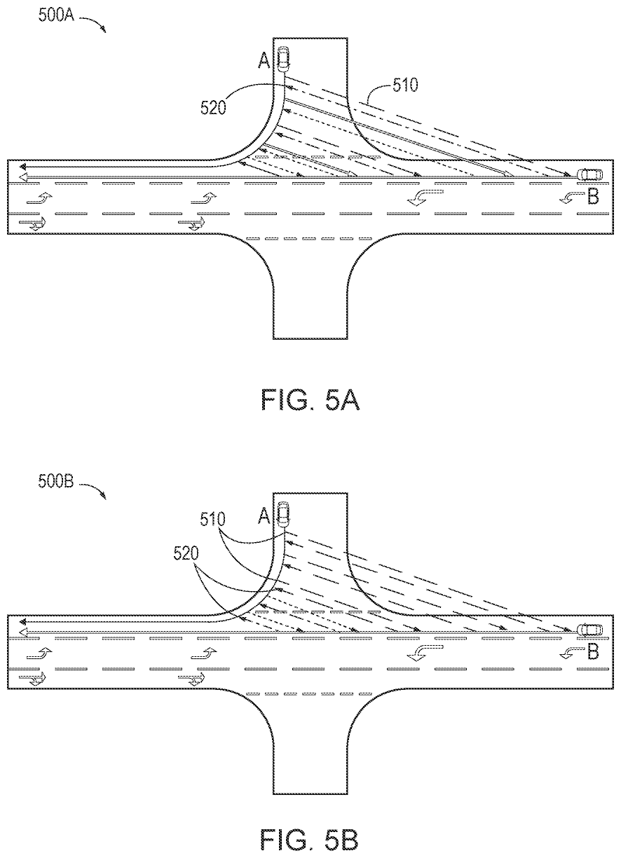

FIGS. 5A-5B are illustrations of exemplary scenarios 500A, 500B in association with discovering interpretable dynamically evolving relations (DIDER), according to one aspect. FIG. 5A is an exemplary illustration of an interaction prediction made not using DIDER, FIG. 5B is an exemplary illustration of an interaction prediction made using DIDER. As seen in FIG. 5A, the interaction prediction made not using DIDER is noisier, less organized as relationships 510, 520 are non-interpretable, where the interaction prediction made using DIDER in FIG. 5B is less noisy, more organized, and thus, relationships 510, 520 are more interpretable than the interaction prediction of FIG. 5A. The use of DIDER disentangles the task of interaction prediction into sub-interaction prediction and duration estimation, which provides interpretable dynamic interactions. By learning duration along with interaction type or edge type, DIDER guides the DIDER model to learn consistent sub-interactions for an extended duration of time.

As seen in FIGS. 5A-5B, there is an intersection, a Vehicle A, and a Vehicle B. Vehicle A may desire to make a right turn, and Vehicle B may desire to travel in a straight line from right to left. Vehicle A may yield when it is noted that Vehicle B is approaching the intersection. After Vehicle B passes, Vehicle A may make its right turn. In this regard, there may be a semantic meaning to their interactions. For example, in the beginning, Vehicle A may see Vehicle B, and when Vehicle B is far, there may be no interaction between them. But later on, when vehicle A approaches the intersection and is closer than a threshold distance, then Vehicle A may stop and see the Vehicle B and consider yielding. Maybe for that particular division, the interaction between Vehicle A and Vehicle B is yielding. In this way, Vehicle A may yield to vehicle B, but vehicle B will not yield to vehicle A. These are the interactions which may be predicted by DIDER.

Interactions which are not predicted by the DIDER model may be noisy, and may not make any sense. Predictions made by the DIDER model, on the other hand, may be easier to visualize, and therefore, more a meaningful interpretation on these interactions may be estimated.

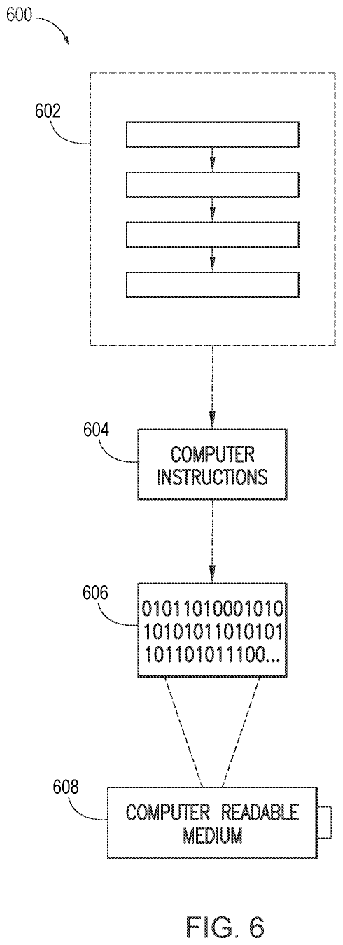

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the computer-implemented method 200 of FIG. 2. In another aspect, the processor-executable computer instructions 604 may be configured to implement a system, such as the system 100 for discovering interpretable dynamically evolving relations (DIDER) of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

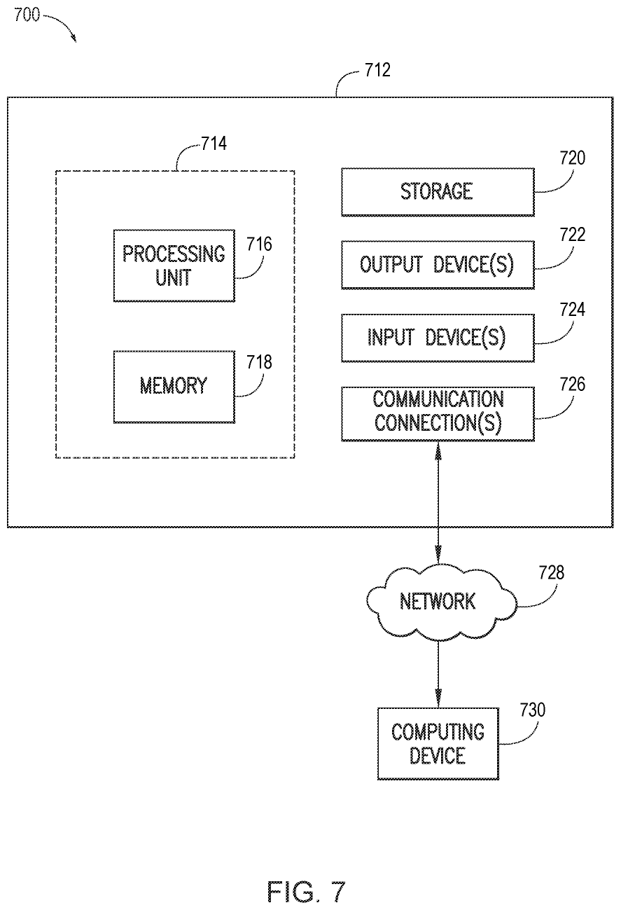

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by the at least one processing unit 716, for example.

The term “computer readable media” as used herein includes computer storage media. Computer storage media includes volatile and nonvolatile, removable, and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for discovering interpretable dynamically evolving relations (DIDER), comprising:
a memory storing one or more instructions; and
a processor executing one or more of the instructions stored on the memory to perform learning a DIDER model for multi-agent interactions represented by a set of edge embeddings indicative of trajectory interactions between two or more agents for one or more time steps by:
feeding the set of edge embeddings to a long short-term memory network (LSTM) forward to generate an LSTM forward output;
feeding the set of edge embeddings to a long short-term memory network (LSTM) reverse to generate an LSTM reverse output;
feeding the LSTM forward output to a duration encoder to generate an edge duration output; and
training the DIDER model based on a probability distribution for one or more different edge types obtained by feeding the LSTM forward output or the LSTM reverse output to an edge prior and an edge encoder.

2. The system for DIDER of claim 1, wherein the set of edge embeddings indicative of trajectory interactions between two or more agents is derived from a graph neural network (GNN) wherein nodes of the GNN represent the two or more agents and edges of the GNN represent relationships between two connected nodes.

3. The system for DIDER of claim 1, wherein the edge encoder is conditioned on full trajectories for all time steps.

4. The system for DIDER of claim 1, wherein the edge prior is conditioned on an observation and a relation prediction from a previous time step.

5. The system for DIDER of claim 1, wherein the processor feeds an output of the edge encoder to a decoder to predict future states of two or more of the agents.

6. The system for DIDER of claim 5, wherein the decoder includes a multi-layer perceptron (MLP).

7. The system for DIDER of claim 1, wherein the processor trains the DIDER model based on maximizing an evidence lower bound (ELBO).

8. The system for DIDER of claim 1, wherein the LSTM reverse output is indicative of future states of the set of edge embeddings.

9. The system for DIDER of claim 1, wherein the processor feeds a concatenation of the LSTM forward output and the LSTM reverse output to the edge encoder.

10. The system for DIDER of claim 1, wherein the edge prior or the edge encoder are implemented via a softmax function.

11. A computer-implemented method for discovering interpretable dynamically evolving relations (DIDER) by learning a DIDER model for multi-agent interactions represented by a set of edge embeddings indicative of trajectory interactions between two or more agents for one or more time steps, comprising:
feeding the set of edge embeddings to a long short-term memory network (LSTM) forward to generate an LSTM forward output;
feeding the set of edge embeddings to a long short-term memory network (LSTM) reverse to generate an LSTM reverse output;
feeding the LSTM forward output to a duration encoder to generate an edge duration output; and
training the DIDER model based on a probability distribution for one or more different edge types obtained by feeding the LSTM forward output or the LSTM reverse output to an edge prior and an edge encoder.

12. The computer-implemented method for DIDER of claim 11, wherein the set of edge embeddings indicative of trajectory interactions between two or more agents is derived from a graph neural network (GNN) wherein nodes of the GNN represent the two or more agents and edges of the GNN represent relationships between two connected nodes.

13. The computer-implemented method for DIDER of claim 11, wherein the edge encoder is conditioned on full trajectories for all time steps.

14. The computer-implemented method for DIDER of claim 11, wherein the edge prior is conditioned on an observation and a relation prediction from a previous time step.

15. A system for discovering interpretable dynamically evolving relations (DIDER), comprising:
a memory storing one or more instructions; and
a processor executing one or more of the instructions stored on the memory to perform DIDER using a DIDER model for multi-agent interactions represented by an execution set of edge embeddings indicative of trajectory interactions between two or more agents for one or more time steps, wherein the DIDER model is trained by:
feeding a training set of edge embeddings to a long short-term memory network (LSTM) forward to generate an LSTM forward output;
feeding the training set of edge embeddings to a long short-term memory network (LSTM) reverse to generate an LSTM reverse output;
feeding the LSTM forward output to a duration encoder to generate an edge duration output; and
training the DIDER model based on a probability distribution for one or more different edge types obtained by feeding the LSTM forward output or the LSTM reverse output to an edge prior and an edge encoder.

16. The system for DIDER of claim 15, wherein the training set of edge embeddings indicative of trajectory interactions between two or more agents is derived from a graph neural network (GNN) wherein nodes of the GNN represent the two or more agents and edges of the GNN represent relationships between two connected nodes.

17. The system for DIDER of claim 15, wherein the edge encoder is conditioned on full trajectories for all time steps.

18. The system for DIDER of claim 15, wherein the edge prior is conditioned on an observation and a relation prediction from a previous time step.

19. The system for DIDER of claim 15, wherein the processor feeds an output of the edge encoder to a decoder to predict future states of two or more of the agents.

20. The system for DIDER of claim 19, wherein the decoder includes a multi-layer perceptron (MLP).
